(19) United States
(12) Patent Application Publication
(10) Pub. No.: US 2016/0326423 A1
(43) Pub. Date: Nov. 10, 2016

(54) DOWNHOLE FLUID COMPOSITIONS AND METHODS OF USING CARBON BLACK PARTICLES

(71) Applicant: BAKER HUGHES INCORPORATED, Houston, TX (US)

(72) Inventors: Jianzhong Yang, Missouri City, TX (US); Erna Kakadjian, The Woodlands, TX (US); Alyssa R. Garcia, Houston, TX (US); Dennis K. Clapper, Houston, TX (US); Rosa Swartwout, Spring, TX (US)

(73) Assignee: BAKER HUGHES INCORPORATED, Houston, TX (US)

(21) Appl. No.: 14/746,350

(22) Filed: Jun. 22, 2015

Related U.S. Application Data
(63) Continuation-in-part of application No. 14/703,282, filed on May 4, 2015.

(51) Int. Cl. C09K 8/32; C09K 8/74; E21B 43/26; E21B 21/00; E21B 33/13; C09K 8/64; C09K 8/467

(52) U.S. Cl. CPC C09K 8/32; C09K 8/64; C09K 8/74; C09K 8/467; E21B 21/00; E21B 33/13; E21B 43/26

(57) ABSTRACT

Carbon black particles and/or optional additional particle(s) may be introduced into fluids, such as drilling fluids, completion fluids, production fluids, stimulation fluids, and combinations thereof. The carbon black particles and/or optional additional particle(s) may increase the electrical and/or thermal conductivity, enhance the stability of an emulsion, improve wellbore strength, improve drag reduction properties, decrease corrosion, and the like. In a non-limiting embodiment, the base fluid may include a brine having at least one multivalent cation.

### CROSS REFERENCE TO RELATED APPLICATIONS

This application is a Continuation-in-Part and claims priority to U.S. application Ser. No. 14/703,282 filed on May 4, 2015, which is incorporated by reference herein in its entirety.

### TECHNICAL FIELD

The present invention relates to fluid compositions and methods of circulating a fluid composition having a downhole based fluid and carbon black particles.

### BACKGROUND

Carbon black is a material produced by the incomplete combustion of heavy petroleum products, such as but not limited to, FCC tar, coal tar, ethylene cracking tar, vegetable oil, and combinations thereof. Carbon black has a high surface-area-to-volume ratio because of its paracrystalline carbon structure.

Carbon black has been mixed with many different materials to improve the properties of end use applications. For example, carbon black is widely used as a rubber-reinforcing filler in tires and various industrial rubber products, as well as a colorant for printing inks, paints, coatings, etc. Since the surface of carbon black largely comprises graphitic crystallites, it has a certain inherent degree of electrical conductivity and thus is also used as a filler for the purpose of imparting electrostatic properties to plastics, paints, and other non-conductive materials. In order to gain acceptable electrical conductivity without high loadings (and higher stiffness), carbon black may be chemically oxidized such that only a hollow “shell” of the graphitic carbon black structure remains. This has the effect of significantly reducing the density of the carbon black, allowing equivalent conductivity with a lower carbon black/polymer ratio.

Carbon black nanoparticles (or larger carbon black particles) have been added to downhole fluids to improve the electrical conductivity imparted to the fluid. However, the electrical conductivity of the carbon black nanoparticles does not seem to translate into the downhole fluids from the carbon black nanoparticles.

Downhole fluids, such as drilling fluids, completion fluids, stimulation fluids, fracturing fluids, acidizing fluids, and remediation fluids for subterranean oil and gas wells are known. Drilling fluids are typically classified according to their base fluid. In water-based fluids, solid particles are suspended in a continuous phase consisting of water or brine. Oil can be emulsified in the water, which is the continuous phase. “Water-based fluid” is used herein to include fluids having an aqueous continuous phase where the aqueous continuous phase can be all water or brine, an oil-in-water emulsion, or an oil-in-brine emulsion. Brine-based fluids, of course are water-based fluids, in which the aqueous component is brine.

Oil-based fluids are the opposite or inverse of water-based fluids. “Oil-based fluid” is used herein to include fluids having a non-aqueous continuous phase where the non-aqueous continuous phase is all oil, a non-aqueous fluid, a water-in-oil emulsion, a water-in- non-aqueous emulsion, a brine-in-oil emulsion, or a brine-in- non-aqueous emulsion. In oil-based fluids, solid particles are suspended in a continuous phase consisting of oil or another non-aqueous fluid. Water or brine can be emulsified in the oil; therefore, the oil is the continuous phase. In oil-based fluids, the oil may consist of any oil or water-immiscible fluid that may include, but is not limited to, diesel, mineral oil, esters, refinery cuts and blends, or alpha-olefins. Oil-based fluid as defined herein may also include synthetic-based fluids or muds (SBMs), which are synthetically produced rather than refined from naturally occurring materials. Synthetic-based fluids often include, but are not necessarily limited to, olefin oligomers of ethylene, esters made from vegetable fatty acids and alcohols, ethers and polyethers made from alcohols and polyalcohols, paraffinic, or aromatic, hydrocarbons alkyl benzenes, terpenes and other natural products and mixtures of these types.

For some applications, in particular for the use of some wellbore imaging tools, it is important to reduce the electrical resistivity (which is equivalent to increasing the electrical conductivity) of the oil-based fluid as the electrical conductivity of the fluids has a direct impact on the image quality. Certain resistivity logging tools, such as high resolution LWD tool STARTRAK™, available from Baker Hughes Inc, require the fluid to be electrically conductive to obtain the best image resolution. Water-based fluids, which are typically highly electrically conductive with a resistivity less than about 100 Ohm-m, are typically preferred for use with such tools in order to obtain a high resolution from the LWD logging tool.

However, oil based fluids are preferred in certain formation conditions, such as those with sensitive shales, or high pressure high temperature (HPHT) conditions where corrosion is abundant. Oil-based fluids are a challenge to use with high resolution resistivity tool, e.g. StarTrak™ because oil-based fluids have a low electrical conductivity (i.e. high resistivity). It would be highly desirable if fluid compositions and methods could be devised to increase the electrical conductivity of the oil-based or non-aqueous-liquid-based drilling, completion, production, and remediation fluids and thereby allow for better utilization of resistivity logging tools.

There are a variety of functions and characteristics that are expected of completion fluids. The completion fluid may be placed in a well to facilitate final operations prior to initiation of production. Completion fluids are typically brines, such as chlorides, bromides, formates, but may be any non-damaging fluid having proper density and flow characteristics. Suitable salts for forming the brines include, but are not necessarily limited to, sodium chloride, calcium chloride, zinc chloride, potassium chloride, potassium bromide, sodium bromide, calcium bromide, zinc bromide, sodium formate, potassium formate, ammonium formate, cesium formate, and mixtures thereof.

Chemical compatibility of the completion fluid with the reservoir formation and fluids is key. Chemical additives, such as polymers and surfactants are known in the art for being introduced to the brines used in well servicing fluids for various reasons that include, but are not limited to, increasing viscosity, and increasing the density of the brine. Water-thickening polymers serve to increase the viscosity of the brines and thus retard the migration of the brines into the formation and lift drilled solids from the wellbore. A regular drilling fluid is usually not compatible for completion operations because of its solid content, pH, and ionic composition. Completion fluids also help place certain completion-related equipment, such as gravel packs, without damaging the producing subterranean formation zones. Modifying the electrical conductivity and resistivity of completion fluids may allow the use of resistivity logging tools for facilitating final operations.

A stimulation fluid may be a treatment fluid prepared to stimulate, restore, or enhance the productivity of a well, such as fracturing fluids and/or matrix stimulation fluids in one non-limiting example.

Servicing fluids, such as remediation fluids, workover fluids, and the like, have several functions and characteristics necessary for repairing a damaged well. Such fluids may be used for breaking emulsions already formed and for removing formation damage that may have occurred during the drilling, completion and/or production operations. The terms “remedial operations” and “remediate” are defined herein to include a lowering of the viscosity of gel damage and/or the partial or complete removal of damage of any type from a subterranean formation. Similarly, the term “remediation fluid” is defined herein to include any fluid that may be useful in remedial operations.

Before performing remedial operations, the production of the well must be stopped, as well as the pressure of the reservoir contained. To do this, any tubing-casing packers may be unseated, and then servicing fluids are run down the tubing-casing annulus and up the tubing string. These servicing fluids aid in balancing the pressure of the reservoir and prevent the influx of any reservoir fluids. The tubing may be removed from the well once the well pressure is under control. Tools typically used for remedial operations include wireline tools, packers, perforating guns, flow-rate sensors, electric logging sondes, etc.

It is generally believed that the carbon black particles need to have a Brunauer-Emmett-Teller (BET) surface area of at least 500 m²/g, and preferably 1500 m̂2/g or greater. However, carbon black particles with this BET surface area range create other problems with brine cation compatibility, specifically making the base fluid too viscous to handle. As such, only monovalent brines can be used for making base fluids including carbon black particles, even though multivalent brines are preferred for many types of base fluids.

It would be desirable if the aforementioned fluid compositions could incorporate carbon black particles and/or base fluids having multivalent brines therein.

### SUMMARY

There is provided, in one non-limiting form, a fluid composition comprising a fluid composition having a base fluid, at least one multivalent metal cation, and carbon black particles. “Multivalent” means the ionic strength is greater than +1, e.g. +2 or greater. The fluid composition may include a drilling fluid, a completion fluid, a production fluid, a stimulation fluid, and combinations thereof; wherein the base fluid comprises a brine having at least one multivalent metal cation. The brine may be incorporated into an oil-based fluid or a water-based fluid.

In an alternative embodiment of the fluid composition, the fluid composition may include a base fluid and carbon black particles having a Brunauer-Emmett-Teller (BET) surface area less than about 450 m²/g. The base fluid may be or include a drilling fluid, a completion fluid, a production fluid, a stimulation fluid, and combinations thereof.

In another non-limiting form, a method may include circulating a fluid composition into a subterranean reservoir wellbore. The fluid composition may have or include a base fluid and carbon black particles. The base fluid may be or include, but is not limited to, a drilling fluid, a completion fluid, a production fluid, a stimulation fluid, and combinations thereof. The base fluid may include a brine having at least one multivalent metal cation. The brine may be incorporated into an oil-based fluid or a water-based fluid.

In another non-limiting form, the method may include circulating a fluid composition into a subterranean reservoir wellbore. The fluid composition may include a base fluid and carbon black particles having a BET surface area less than about 450 m²/g. The base fluid may be or include a drilling fluid, a completion fluid, a production fluid, a stimulation fluid, and combinations thereof.

### DETAILED DESCRIPTION

It has been discovered that a fluid composition having a base fluid and carbon black particles may be used to increase the electrical conductivity of the base fluid. In a non-limiting embodiment, the carbon black particles may be used in conjunction with a brine that includes, but is not limited to, salts having at least one multivalent cation and/or at least one anion. The multivalent cation(s) may be or include lithium, sodium, potassium, rubidium, cesium, magnesium, strontium, manganese, zinc, and combinations thereof. The anion(s) may be or include, but is not limited to, acetates, nitrates, chlorides, bromides, formats, and combinations thereof. The brine may be incorporated into an oil-based fluid or a water-based fluid.

The carbon black particles may be or include acetylene black, channel black, furnace black, lamp black, thermal black, carbon/silica hybrid blacks, and combinations thereof. The carbon black particles and/or optional additional particles may improve the electrical and/or thermal conductivity of the base fluid. Resistivity logging tools require the fluid in the wellbore to be electrically conductive. By including the carbon black particles and/or optional additional particle(s) (described below) in an oil-based fluid or a water-based fluid, the electrical and/or thermal conductivity thereof may be improved and thereby improve the images produced from the resistivity logging tools.

Other benefits that may arise from modifying the electrical conductivity of the fluid composition may include enabling the implementation of measuring tools based on resistivity with superior image resolution, and improving the ability of a driller to improve its efficiency in the non-limiting instance of drilling fluids and/or completion fluids. It may also be conceivable that an electric signal may be able to be carried through the fluid composition across longer distances, such as across widely spaced electrodes in or around the bottom-hole assembly, or even from the bottom of the wellbore to intermediate stations or the surface of the well.

The final electrical conductivity of the downhole fluid composition may be determined by the content and the inherent properties of the dispersed phase content, which may be tailored to achieve desired values of electrical conductivity. The final resistivity (inverse of electrical conductivity) of the fluid composition may range from about 0.02 ohm-m to about 1,000,000 ohm-m in one non-limiting embodiment. In an alternative embodiment, the resistivity of the fluid composition may range from about 0.2 ohm-m to about 10,000 ohm-m, or from about 2 ohm-m to about 5,000 ohm-m. The electronic stability (ES) of the downhole fluid composition may range from about 50 volts independently to about 1000 volts, alternatively from about 100 volts independently to about 750 volts, or from about 250 volts independently to about 500 volts. As used herein with respect to a range, “independently” means that any threshold may be used together with another threshold to give a suitable alternative range, e.g. about 0.02 ohm-m independently to about 0.2 ohm-m is also considered a suitable alternative range.

In a non-limiting embodiment, the carbon black particles may have a Brunauer-Emmett-Teller (BET) surface area less than about 450 m²/g; alternatively, less than about 400 m²/g, or from less than about 350 m²/g in another non-limiting embodiment. Alternatively, the BET surface area may range from about 0.1 m²/g independently to about 450 m²/g, alternatively from about 10 m²/g independently to about 400 m²/g, or from about 100 m²/g independently to about 350 m²/g in another non-limiting embodiment. The BET surface area being less than about 450 m²/g may allow for better incorporation of the carbon black particles when used in conjunction with multivalent cationic brines within a base fluid in a non-limiting embodiment. The low BET surface area of the carbon black particles may also maintain good rheology/viscosity profile for the base fluid when used in conjunction with multivalent brines. In a non-limiting embodiment, the viscosity of the fluid composition ranges from about 10 independently to about 1000 centipoise (cp), alternatively from about 20 cp independently to about 500 cpor from about 25independently to about 75 cp in another non-limiting embodiment.

The amount of the carbon black particles necessary to increase the electrical conductivity of the base fluid may vary depending on a number of factors, such as but not limited to, the depth within a wellbore, the temperature of the environment, the pressure of the environment, the size of the particles, and the like. However, the amount of the carbon black particles within the fluid composition may range from about 0.0001 wt % independently to about 25 wt %, alternatively from about 0.1 wt % independently to about 10 wt %, or from about 1 wt % independently to about 5 wt %.

In a non-limiting embodiment, the fluid composition may also include at least one optional additional particle(s) different from the carbon black particles, such as but not limited to metal carbonyl particles, metal nanoparticles, carbon-based particles different from the carbon black, and combinations thereof. The optional additional particle(s) may be present in the fluid composition in an amount ranging from about 0.0001 wt % independently to about 25 wt %, alternatively from about 0.1 wt % independently to about 10 wt %, or from about 1 wt % independently to about 5 wt %.

‘Carbon-based nanoparticles’ are defined herein to be nanoparticles having at least 50 mole % or greater of carbon atoms; ‘carbon-based nanoparticles’ is used herein to discuss other carbon-based nanoparticles that are different from the carbon black particles described. Non-limiting examples of carbon-based nanoparticles include, but are not limited to, graphene nanoparticles, graphene platelets, graphene oxide, nanorods, nanoplatelets, graphite nanoparticles, nanotubes, and combinations thereof. ‘Nanoparticles’ as used herein means the particles has an at least one dimension less than about 999 nm; alternatively, the nanoparticle has an average particle size of less than 999 nm.

Graphene is an allotrope of carbon having a planar sheet structure that has sp²-bonded carbon atoms densely packed in a 2-dimensional honeycomb crystal lattice. The term “graphene” is used herein to include particles that may contain more than one atomic plane, but still with a layered morphology, i.e. one in which one of the dimensions is significantly smaller than the other two, and also may include any graphene that has been functionally modified. The structure of graphene is hexagonal, and graphene is often referred to as a 2-dimensional (2-D) material. The 2-D morphology of the graphene nanoparticles is of utmost importance when carrying out the useful applications relevant to the graphene nanoparticles. The applications of graphite, the 3-D version of graphene, are not equivalent to the 2-D applications of graphene. The graphene may have at least one graphene sheet, and each graphene platelet may have a thickness no greater than 100 nm.

Graphene is in the form of one-atomic layer thick or multi-atomic layer thick platelets. Graphene platelets may have in-plane dimensions ranging from sub-micrometer to about 100 micrometers. This type of platelet shares many of the same characteristics as carbon nanotubes. The platelet chemical structure makes it easier to functionally modify the platelet for enhanced dispersion in polymers. Graphene platelets provide electrical conductivity that is similar to copper, but the density of the platelets may be about four times less than that of copper, which allows for lighter materials. The graphene platelets may also be fifty (50) times stronger than steel with a BET surface area that is twice that of carbon nanotubes.

Graphene may form the basis of several nanoparticle types, such as but not limited to the graphite nanoparticle, nanotubes, fullerenes, and the like. Several graphene sheets layered together may form a graphite nanoparticle. In a non-limiting embodiment, a graphite nanoparticle may have from about 2 layered graphene sheets to about 20 layered graphene sheets to form the graphite nanoparticle, or from about 3 layered graphene sheets to about 25 layered graphene sheets in another non-limiting example. Graphene nanoparticles may range from about 1 independently to about 50 nanometers thick, or from about 3 nm independently to about 25 nm thick.

Graphite nanoparticles are graphite (natural or synthetic) species downsized into a submicron size by a process, such as but not limited to a mechanic milling process to form graphite platelets, or a laser ablating technique to form a graphite nanoparticle having a spherical structure. The spherical structure may range in size from about 30 nm independently to about 999 nm, or from about 50 nm independently to about 500 nm. In a non-limiting embodiment, the spherical graphite nanoparticles may have a 3D structure. Graphite nanoparticles have different chemical properties because of the layered graphene effect, which allows them to be more electrically conductive than a single graphene sheet.

In another non-limiting embodiment, the graphene sheet may form a substantially spherical structure having a hollow inside, which is known as a fullerene. This cage-like structure allows a fullerene to have different properties or features as compared to graphite nanoparticles or graphene nanoparticles. For the most part, fullerenes are stable structures, but a non-limiting characteristic reaction of a fullerene is an electrophilic addition at 6,6 double bonds to reduce angle strain by changing an sp²-hydridized carbon into an sp³-hybridized carbon. In another non-limiting example, fullerenes may have other atoms trapped inside the hollow portion of the fullerene to form an endohedral fullerene. Metallofullerenes are non-limiting examples where one or two metallic atoms are trapped inside of the fullerene, but are not chemically bonded within the fullerene. Although fullerenes are not electrically conductive, alone, a functional modification to the fullerene may enhance a desired property thereto. Such functional modifications may be chemical modifications, physical modifications, covalent modifications, and/or surface modifications to form a functionalized fullerene.

Coke particles may have or include a green coke component, a calcined coke component, and combinations thereof. The green coke component may be an insoluble organic deposit that has low hydrogen content typically formed from hydrocracking, thermal cracking, and/or distillation during the refining of crude oil or bitumen fluids. Coke is also known as pyrobitumen. Calcined coke may be created by placing the green coke into a rotary kiln and heating the green coke at a temperature ranging from about 200 C to about 1500 C to remove excess moisture, extract any remaining hydrocarbons, and modify the crystalline structure of the coke. The calcined coke has a denser more electrically conductive product than the green coke.

The base fluid may be or include a drilling fluid, a completion fluid, a production fluid, a stimulation fluid, and combinations thereof. The carbon black particles and/or optional additional particles may be added or dispersed into at least one phase of the base fluid, such as the continuous phase in a non-limiting embodiment. In a non-limiting embodiment, the base fluid may be an emulsion, and the carbon black particles and/or optional additional particle(s) may improve the stability of the emulsion. In addition or in the alternative, the carbon black particles and/or optional additional particles may strengthen a wellbore once the fluid composition has been circulated therein. Other benefits of the carbon black particles and/or optional additional particles include reducing turbulence in a pipeline as a drag reducing agent, lubricating a drill bit, altering the wettability of a formation surface or a wellbore surface, decreasing corrosion to a surface (i.e. a drill bit, a pipeline, a wellbore, etc.), and the like.

The carbon black particles and/or additional particle(s) may be in the form of a particle, an aggregate, or an agglomerate. “Particles” may be carbon black and/or optional additional particle(s) formed at the early stages of the carbon black or other particle (e.g. metal nanoparticles or other carbon-based nanoparticles) process; particles cannot be subdivided by ordinary means. “Aggregate” refers to an accumulation of carbon black particles and/or optional additional particle(s) that are fused together and tightly bonded. Aggregates may not be broken down into individual particles through mechanical means, particularly aggregates are being combined with other materials in a mixing operation. “Agglomerate” refers to an accumulation of aggregates that are generally held together by weaker physical (e.g., Van der Waals) forces and may be separated by mechanical means, such as during a mixing operation.

It should be understood that the carbon black particles and/or optional additional particle(s) may be surface-modified nanoparticles, which may find utility in the compositions and methods herein. “Surface-modification” is defined here as the process of altering or modifying the surface properties of a particle by any means, including but not limited to physical, chemical, electrochemical or mechanical means, and with the intent to provide a unique desirable property or combination of properties to the surface of the carbon black particles and/or optional additional particle(s), which differs from the properties of the surface of the unprocessed carbon black particles and/or optional unprocessed additional particle(s).

In some non-limiting embodiments, the carbon black particles and/or optional additional particle(s) may be functionally modified to form functionalized carbon black particles and/or functionalized optional additional particle(s). The carbon black particles and/or optional additional particle(s) whether the particles are functionalized or non-functionalized. Capped particles have at least one oxygen species thereon that is capped to decrease the oxygen reactivity as compared to the non-capped particles. The oxygen species that may be capped may include, but are not limited to carboxylic acids, ketones, lactones, anhydrides, hydroxyls, and combinations thereof present on or within the carbon black particles and/or optional additional particle(s).

Capping functionalized carbon black particles and/or functionalized optional additional particle(s) may result in a semi-muted functionalization. Said differently, the capped functionalization may still maintain some of the functionalized characteristics imparted to the functionalized carbon black particles and/or optional additional particle(s), but to a lesser extent than a fully functionalized carbon black particles and/or optional additional particle(s) that have not been capped. One skilled in the art would recognize when to cap or not cap a functionalized or non-functionalized carbon black particles and/or optional additional particle(s).

‘Functionalized’ is defined herein to be carbon black particles and/or optional additional particle(s) having an increased or decreased functionality, and the ‘functional modification’ is the process by which the carbon black particles and/or optional additional particle(s) have had a particular functionality increased or decreased. The functional group may be or include, but is not limited to, a sulfonate, a sulfate, a sulfosuccinate, a thiosulfate, a succinate, a carboxylate, a hydroxyl, a glucoside, an ethoxylate, a propoxylate, a phosphate, an ethoxylate, an ether, an amine, an amide, an alkyl, an alkenyl, a phenyl, benzyl, a perfluoro, thiol, an ester, an epoxy, a keto group, a lactone, a metal, an organometallic group, an oligomer, a polymer, and combinations thereof.

The functionalized carbon black particles and/or optional additional particle(s) may have different functionalities than carbon black particles and/or optional additional particle(s) that have not been functionally modified. In a non-limiting embodiment, the functional modification of the carbon black particles and/or optional additional particle(s) may improve the dispersibility of the carbon black particles and/or optional additional particle(s) in an oil-based fluid by stabilizing the carbon black particles and/or optional additional particle(s) in suspension, which avoids undesirable flocculation as compared with otherwise identical carbon black particles and/or optional additional particle(s) that have not been functionally modified. In one non-limiting embodiment of the invention, it is desirable that the conductivity properties of the fluid be uniform, which requires the distribution of the carbon black particles and/or optional additional particle(s) to be uniform. If the carbon black particles and/or optional additional particle(s) flocculate, drop out, or precipitate, the electrical conductivity of the fluid may change.

The capping to the carbon black particles and/or optional additional particle(s) may occur by use of a capping component, such as but not limited to, metal carbonyl species, metal nanoparticles, and combinations thereof. The capping may occur to the carbon black particles and/or optional additional particle(s) by a method, such as but not limited to, physical capping, chemical capping, and combinations thereof. The carbon black particles and/or optional additional particle(s) may or may not be functionally modified prior to capping the carbon black particles and/or optional additional particle(s). In a non-limiting embodiment, the carbon black particles and/or optional additional particle(s) are capped (e.g. physical and/or chemical capping) when present within the base fluid.

A physical capping may occur by altering the ability of the oxygen species on or within the carbon black particles and/or optional additional particle(s) by decreasing/eliminating electrostatic interactions, ionic interactions, and the like. Alternatively, physical capping may occur by physical absorption of the oxygen species, such as by chemical vapor deposition under thermolysis in a non-limiting embodiment. In a non-limiting example, metal carbonyl species may be used to aid in physically capping the carbon black particles and/or optional additional particle(s), such as but not limited to platinum carbonyls, gold carbonyls, silver carbonyls, copper carbonyls, and combinations thereof. In an alternative non-limiting embodiment, metal nanoparticles may be used for physically capping the carbon black particles and/or optional additional particle(s), such as but not limited to platinum nanoparticles, gold nanoparticles, silver nanoparticles, copper nanoparticles, and combinations thereof.

In a non-limiting embodiment, the carbon black particles and/or optional additional particle(s) may be encapsulated prior to physically capping the carbon black particles and/or optional additional particle(s); alternatively, the carbon black particles and/or optional additional particle(s) may not be encapsulated prior to physically capping the carbon black particles and/or optional additional particle(s).

The amount of metal carbonyl species and/or the amount of metal nanoparticles for capping the carbon black particles and/or optional additional particle(s) may range from about 0.1 wt % independently to about 10 wt % in a non-limiting embodiment, alternatively from about 1 wt % independently to about 5 wt %.

A chemical capping may occur by modifying chemical bonds of the carbon black particles and/or optional additional particle(s) to alter the oxygen reactivity thereto, chemical absorption of the oxygen species, and the like. A non-limiting example of a chemical capping may include altering the polarity of an oxygen species of the carbon black particles and/or optional additional particle(s) to be a non-polar or less polar oxygen species. Other non-limiting examples of chemical capping may occur by performing a reaction with the oxygen species with the appropriate reactant for each reaction, such as but not limited to a Grignard reaction, an alkyl esterification, an amidation, silanation with organic silanes, and combinations thereof. For each type of chemical capping reaction, the amount of respective reactants may range from about 1 wt % independently to about 5 wt %.

In a non-limiting embodiment, carbon black particles and/or optional additional particle(s) may have at least one functional group attached thereto and/or may be covalently modified. Introduction of functional groups by derivatizing the olefinic functionality associated with the carbon black particles and/or optional additional particle(s) may be affected by any of numerous known methods for direct carbon-carbon bond formation to an olefinic bond, or by linking to a functional group derived from an olefin. Exemplary methods of functionally modifying may include, but are not limited to, reactions such as oxidation or oxidative cleavage of olefins to form alcohols, diols, or carbonyl groups including aldehydes, ketones, or carboxylic acids; diazotization of olefins proceeding by the Sandmeyer reaction; intercalation/metallization of a nanodiamond by treatment with a reactive metal such as an alkali metal including lithium, sodium, potassium, and the like, to form an anionic intermediate, followed by treatment with a molecule capable of reacting with the metalized nanodiamond such as a carbonyl-containing species (carbon dioxide, carboxylic acids, anhydrides, esters, amides, imides, etc.), an alkyl species having a leaving group such as a halide (Cl, Br, I), a tosylate, a mesylate, or other reactive esters such as alkyl halides, alkyl tosylates, etc.; molecules having benzylic functional groups; use of transmetalated species with boron, zinc, or tin groups which react with e.g., aromatic halides in the presence of catalysts such as palladium, copper, or nickel, which proceed via mechanisms such as that of a Suzuki coupling reaction or the Stille reaction; pericyclic reactions (e.g., 3 or 4+2) or thermocyclic (2+2) cycloadditions of other olefins, dienes, heteroatom substituted olefins, and combinations thereof.

The covalent modification to carbon black particles and/or optional additional particle(s) may include, but is not necessarily limited to, oxidation and subsequent chemical modification of oxidized carbon black particles and/or optional oxidized additional particle(s), fluorination, free radical additions, addition of carbenes, nitrenes and other radicals, arylamine attachment via diazonium chemistry, and the like. Besides covalent modification, chemical modification may occur by introducing noncovalent functionalization, electrostatic interactions, π-π interactions and polymer interactions, such as wrapping a carbon black particle and/or optional additional particle with a polymer, direct attachment of reactants to the carbon black particles and/or optional additional particle(s) by attacking the sp² bonds, direct attachment to ends of the carbon black particles and/or optional additional particle(s) or to the edges of the carbon black particles and/or optional additional particle(s), and the like.

It will be appreciated that the above methods are intended to illustrate the concept of functionally and/or covalently modifying the carbon black particles and/or optional additional particle(s) to introduce functional groups thereto, and should not be considered as limiting to such methods.

Prior to functional modification, the carbon black particles and/or optional additional particle(s) may be exfoliated. Exemplary exfoliation methods include, but are not necessarily limited to, those practiced in the art, such as fluorination, acid intercalation, acid intercalation followed by thermal shock treatment, and the like. Exfoliation of the carbon black particles and/or optional additional particle(s) provides the carbon black particles and/or optional additional particle(s) having fewer layers than non-exfoliated carbon black particles and/or optional additional particle(s).

The effective medium theory states that properties of materials or fluids comprising different phases can be estimated from the knowledge of the properties of the individual phases and their volumetric fraction in the mixture. In particular if a conducting particle is dispersed in a dielectric fluid, the electrical conductivity of the dispersion will slowly increase for small additions of the carbon black particles and/or optional additional particle(s). As the carbon black particles and/or optional additional particle(s) are continually added to the dispersion, the conductivity of the fluid increases, i.e. there is a strong correlation between increased conductivity and increased concentration of the carbon black particles and/or optional additional particle(s). This concentration is often referred to as the percolation limit.

In the present context, the carbon black particles and/or optional additional particle(s) may have at least one dimension less than 999 nm, alternatively less than 100 nm, or less than 50 nm in another non-limiting embodiment, although other dimensions may be larger than this. In a non-limiting embodiment, the carbon black particles and/or optional additional particle(s) may have one dimension less than 30 nm, or alternatively 10 nm. In one non-limiting instance, the smallest dimension of the carbon black particles and/or optional additional particle(s) may be less than 5 nm, but the length of the carbon black particles and/or optional additional particle(s) may be much longer than 100 nm, for instance 25000 nm or more. Alternatively, the average nanoparticle size of the carbon black particles and/or optional additional particle(s) are less than 999 nm, alternatively less than 100 nm, or less than 50 nm in another non-limiting embodiment. Such carbon black particles and/or optional additional particle(s) would be within the scope of the fluids herein.

The carbon black particles and/or optional additional particle(s) typically have at least one dimension less than 100 nm (one hundred nanometers). While materials on a micron scale have properties similar to the larger materials from which they are derived, assuming homogeneous composition, the same is not true of carbon black nanoparticles and/or optional additional nanoparticle(s). An immediate example is the very large interfacial or BET surface area per volume for the carbon black nanoparticles and/or optional additional nanoparticle(s). The consequence of this phenomenon is a very large potential for interaction with other matter, as a function of volume. Additionally, because of the very large BET surface area to volume present with the carbon black nanoparticles and/or optional additional nanoparticle(s), it is expected that in most, if not all cases, much less proportion of the carbon black nanoparticles and/or optional additional nanoparticle(s) need be employed relative to micron-sized additives conventionally used to achieve or accomplish a similar effect.

In the case of electrical conductivity, conductivity of nanofluids (i.e. dispersion of the carbon black nanoparticles and/or optional additional nanopartice(s) in fluids), the percolation limit decreases with decreasing the size of the carbon black nanoparticles and/or optional additional nanoparticle(s). This dependence of the percolation limit on the concentration of the carbon black nanoparticles and/or optional additional nanoparticle(s) holds for other fluid properties that depend on inter-particle average distance.

There is also a strong dependence on the shape of the carbon black nanoparticles and/or optional additional nanoparticle(s) dispersed within the phases for the percolation limit of nano-dispersions. The percolation limit shifts further towards lower concentrations of the dispersed phase if the carbon black nanoparticles and/or optional additional nanoparticle(s) have characteristic 2-D (platelets) or 1-D (nanotubes or nanorods) morphology. Thus the amount of 2-D or 1-D carbon black nanoparticles and/or optional additional nanoparticle(s) necessary to achieve a certain change in property is significantly smaller than the amount of 3-D carbon black nanoparticles and/or optional additional nanoparticle(s) that would be required to accomplish a similar effect.

In one sense, such fluids have made use of carbon-based nanoparticles for many years, since the clays commonly used in drilling fluids are naturally-occurring, 1 nm thick discs of aluminosilicates. Such carbon-based nanoparticles exhibit extraordinary rheological properties in water and oil. However, in contrast, the carbon black nanoparticles and/or optional additional nanoparticle(s) that are a topic herein are synthetically formed particles (whether included in the carbon black nanoparticles and/or optional additional nanoparticle(s)) where size, shape and chemical composition are carefully controlled and give a particular property or effect.

In some cases, the carbon black particles and/or optional additional particle(s) may change the properties of the fluids in which they reside, based on various stimuli including, but not necessarily limited to, temperature, pressure, rheology, pH, chemical composition, salinity, and the like. This is due to the fact that the carbon black particles and/or optional additional particle(s) can be custom designed on an atomic level to have very specific functional groups, and thus the carbon black particles and/or optional additional particle(s) react to a change in surroundings or conditions in a way that is beneficial. It should be understood that it is expected that carbon black particles and/or optional additional particle(s) may have more than one type of functional group, making them multifunctional. Multifunctional carbon black particles and/or optional additional particle(s) may be useful for simultaneous applications, in a non-limiting example of a fluid, lubricating the bit, increasing the temperature stability of the fluid, stabilizing the shale while drilling and provide low shear rate viscosity. In another non-restrictive embodiment, carbon black particles and/or optional additional particle(s) suitable for stabilizing shale include those having an electric charge that permits them to associate with the shale.

The use of carbon black particles and/or optional additional particle(s) may form self-assembly structures that may enhance the thermodynamic, physical, and rheological properties of these types of fluids. The carbon black particles and/or optional additional particle(s) are dispersed in the base fluid. The base fluid may be a single-phase fluid or a poly-phase fluid, such as an emulsion of water-in-oil (W/O), oil-in-water (O/W), and the like. The carbon black particles and/or optional additional particle(s) may be used in conventional operations and challenging operations that require stable fluids for high temperature and pressure conditions (HTHP). The brines including the multivalent cations used in conjunction with the carbon black particles may be used in oil based fluid or water based fluids, e.g. W/O emulsions or O/W emulsions.

In another non-limiting embodiment, the fluid composition may include a surfactant in an amount effective to suspend carbon black particles and/or optional additional particle(s) in the base fluid. The surfactant may be present in the fluid composition in an amount ranging from about 1 vol % independently to about 10 vol %, or from about 2 vol % independently to about 8 vol % in another non-limiting embodiment.

Expected suitable surfactants may include, but are not necessarily limited to non-ionic, anionic, cationic, amphoteric surfactants and zwitterionic surfactants, janus surfactants, and blends thereof. Suitable nonionic surfactants may include, but are not necessarily limited to, alkyl polyglycosides, sorbitan esters, methyl glucoside esters, amine ethoxylates, diamine ethoxylates, polyglycerol esters, alkyl ethoxylates, alcohols that have been polypropoxylated and/or polyethoxylated or both. Suitable anionic surfactants may include alkali metal alkyl sulfates, alkyl ether sulfonates, alkyl sulfonates, alkyl aryl sulfonates, linear and branched alkyl ether sulfates and sulfonates, alcohol polypropoxylated sulfates, alcohol polyethoxylated sulfates, alcohol polypropoxylated polyethoxylated sulfates, alkyl disulfonates, alkylaryl disulfonates, alkyl disulfates, alkyl sulfosuccinates, alkyl ether sulfates, linear and branched ether sulfates, alkali metal carboxylates, fatty acid carboxylates, and phosphate esters. Suitable cationic surfactants may include, but are not necessarily limited to, arginine methyl esters, alkanolamines and alkylenediamides. Suitable surfactants may also include surfactants containing a non-ionic spacer-arm central extension, and an ionic or nonionic polar group. Other suitable surfactants may be dimeric or gemini surfactants, cleavable surfactants, janus surfactants and extended surfactants, also called extended chain surfactants.

The fluid composition may be circulated into a subterranean reservoir wellbore, and a downhole tool may be operated with the fluid composition at the same time or different time as the circulating of the fluid composition. In a non-limiting embodiment, the fluid composition may be circulated into a formation comprising a substance, such as but not limited to, cement, lime, carbonates, and combinations thereof. Alternatively, the fluid composition includes a drilling fluid as the base fluid, and the drilling fluid is used to drill into a formation comprising a substance, such as but not limited to, cement, lime, carbonates, and combinations thereof.

After circulating the fluid composition, the method may also include performing a procedure selected from the group consisting of well logging, drilling a well, completing a well, fracturing a formation, acidizing a formation, cementing a subterranean reservoir wellbore, altering the wettability of a formation surface, altering the wettability of a wellbore surface, and combinations thereof. A downhole tool may have an improved image as compared to a downhole tool being operated at the same time or different time as a fluid composition absent the carbon black particles and/or optional additional particle(s). Enhanced electrical conductivity of the fluid composition may form an electrically conductive filter cake that highly improves real time high resolution logging processes, as compared with an otherwise identical fluid absent the carbon black particles and/or optional additional particle(s).

The invention will be further described with respect to the following Examples, which are not meant to limit the invention, but rather to further illustrate the various embodiments.

### EXAMPLE 1

A typical oil base mud was formulated as noted in Table 1. CARBOGEL™ is distributed by Baker Hughes, Inc. and may be a high purity, wet-process, high-yielding organophilic clay used as a viscosifying and suspending agent. The emulsifier was a non-ionic surfactant. MIL-BAR™ is distributed by Baker Hughes, Inc. and was used as a weighting agent. The resistance was measured with a LCR meter, i.e. a meter that measures inductance, capacitance, and/or resistance.

TABLE 1
Resistance and ES of typical oil base mud
Formulation of a barite weighted mud
Oil/water ratio: 75:25

| Components | Weight (g) |
|---|---|
| Hydrocarbon oil | 173 |
| CARBO-GEL ® | 5 |
| Emulsifer | 10.0 |
| CalCl₂ brine | 93.81 |
| MIL-BAR ® | 180.11 |
| Resistance (Ohm) | 1.7E+6 |
| Electrical Stability (ES) (V) | 655 |

### EXAMPLE 2

Three samples having different low Brunauer-Emmett-Teller (BET) surface area carbon black particles were incorporated into an oil based mud formulation; the samples are noted in Table 2 as A, B, and C. Specifically, the carbon black particles in Sample A had a (BET) surface area of about 65 m²/g; the carbon black particles in Sample B had a BET surface area of about 70 m²/g; and the carbon black particles in Sample C had a BET surface area of about 175 m²/g. The emulsifier was the same as that used in Example 1.

The resistance, ES, and mud properties were measured again and listed in the Table 2.

TABLE 2
Electrical Properties for Samples with Carbon Black Particles Having
Different BET Surface Areas

| Components | A | B | C |
|---|---|---|---|
| Hydrocarbon oils | 212.4 | 212.4 | 212.4 |
| Carbon black, ppb | 10 | 10 | 10 |
| Surface area m²/g | 65 | 70 | 175 |
| CARBO-GEL ™ | 3 | 3 | 3 |
| Emulsifer, ppb | 12 | 12 | 12 |
| 20% CaCl₂, ppb | 36.6 | 36.6 | 36.6 |
| Fluid loss control | 2 | 2 | 2 |
| agent, ppb | | | |
| MIL-BAR, ppb | 219 | 219 | 219 |
| Hot Roll @ 250° F. | | | |
| 600 | 53 | 68 | 95 |
| 300 | 33 | 47 | 64 |
| 200 | 26 | 39 | 52 |
| 100 | 19 | 29 | 39 |
| 6 | 9 | 14 | 20 |
| 3 | 8 | 12 | 19 |
| Plastic Viscosity, cp | 20 | 21 | 31 |
| Yield Point, lbs/100 ft² | 13 | 26 | 33 |
| 10 Sec, Gel Strength, | 9 | 14 | 19 |
| #/100 ft2 | | | |
| 10 Min Gel Strength, | 10 | 16 | 19 |
| #/100 ft2 | | | |
| Electrical Stability (V) | 20 | 9 | 8 |
| Resistance(Ohm) | 3.00E+03 | 2.30E+03 | 1.30E+03 |
| High Temperature | 7.6 | 10.0 | 10.0 |
| High Pressure Fluid | | | |
| Loss (ml/30 min) | | | |

As noted from Table 2, the low BET surface areas of the carbon black decreased the resistance of the oil based mud formulation, while also maintaining the conductivity and rheological properties in the presence of a polyvalent calcium brine. Such conductivity and rheological properties were maintained even after the oil-based mud was hot rolled overnight at 250° F. Also worth noting from Table 2, the sample having the lowest BET surface area carbon black particles had the most acceptable rheology and HPHT fluid loss characteristics.

Samples A, B, and C were conductive according to the ES values shown in Table 2. The voltage used to break the oil based mud to make the samples conductive dropped from 650 to less than 20. Said differently, the emulsion became much easier to break after the carbon black particles were included in Samples A-C.

In the foregoing specification, the invention has been described with reference to specific embodiments thereof, and has been suggested as effective in providing effective fluid compositions and methods for properties of a fluid composition having carbon black particles and/or optional additional particle (s) present therein. However, it will be evident that various modifications and changes may be made thereto without departing from the broader spirit or scope of the invention as set forth in the appended claims. Accordingly, the specification is to be regarded in an illustrative rather than a restrictive sense. For example, specific carbon black particles, specific additional particles, base fluids, surfactants, functional groups, and/or covalent modifications not specifically identified or tried in a particular fluid composition or method are anticipated to be within the scope of this invention.

The present invention may suitably comprise, consist or consist essentially of the elements disclosed and may be practiced in the absence of an element not disclosed. For instance, the fluid composition may consist of or consist essentially of a base fluid and carbon black particles where the base fluid may be or include a drilling fluid, a completion fluid, a production fluid, a stimulation fluid, and combinations thereof, and the base fluid may include a brine having at least one multivalent metal cation.

The method may consist of or consist essentially of circulating the fluid composition into a subterranean reservoir wellbore where the fluid composition may have or include a base fluid and carbon black particles; the base fluid may be or include, but is not limited to, a drilling fluid, a completion fluid, a production fluid, a stimulation fluid, and combinations thereof; and the base fluid may include a brine having at least one multivalent metal cation.

The words “comprising” and “comprises” as used throughout the claims is to be interpreted as meaning “including but not limited to”.

What is claimed is:

1. A fluid composition comprising:
a base fluid selected from the group consisting of a drilling fluid, a completion fluid, a production fluid, a stimulation fluid, and combinations thereof;
wherein the base fluid comprises a brine having at least one multivalent metal cation; and
carbon black particles.

2. The fluid composition of claim 1, wherein the amount of the carbon black particles within the fluid composition ranges from about 0.0001 wt % to about 25 wt %.

3. The fluid composition of claim 1 further comprising at least one additional particle selected from the group consisting of metal carbonyl particles, metal nanoparticles, carbon-based particles different from the carbon black particles, and combinations thereof.

4. The fluid composition of claim 1, wherein the carbon black particles are functionally modified carbon black particles having at least one functional group selected from the group consisting of a sulfonate, a sulfate, a sulfosuccinate, a thiosulfate, a succinate, a carboxylate, a hydroxyl, a glucoside, an ethoxylate, a propoxylate, a phosphate, an ethoxylate, an ether, an amine, an amide, an alkyl, an alkenyl, a phenyl, benzyl, a perfluoro, thiol, an ester, an epoxy, a keto group, a lactone, a metal, an organometallic group, an oligomer, a polymer, and combinations thereof.

5. The fluid composition of claim 1, wherein the carbon black particles are covalently-modified carbon black particles having at least one covalent modification selected from the group consisting of oxidation; free radical additions; addition of carbenes, nitrenes and other radicals; arylamine attachment via diazonium chemistry; and combinations thereof.

6. The fluid composition of claim 1, further comprising at least one surfactant in an amount effective to suspend the carbon black particles in the base fluid. The fluid composition of claim 1, wherein the carbon black particles have an average particle size less than about 999 nm.

8. The fluid composition of claim 1, wherein the carbon black particles have a Brunauer-Emmett-Teller (BET) surface area less than about 450 m²/g

9. A fluid composition comprising:
a base fluid selected from the group consisting of a drilling fluid, a completion fluid, a production fluid, a stimulation fluid, and combinations thereof;
and carbon black particles having a Brunauer-Emmett-Teller (BET) surface area less than about 450 m²/g.

10. A method comprising:
circulating a fluid composition into a subterranean reservoir wellbore;
wherein the fluid composition comprises a base fluid selected from the group consisting of a drilling fluid, a completion fluid, a production fluid, a stimulation fluid, and combinations thereof; wherein the base fluid comprises a brine having at least one multivalent metal cation;
and wherein the fluid composition comprises carbon black particles.

11. The method of claim 10, further comprising performing a procedure selected from the group consisting of well logging, drilling a well, completing a well, fracturing a formation, acidizing a formation, cementing a subterranean reservoir wellbore, altering the wettability of a formation surface, altering the wettability of a wellbore surface, and combinations thereof.

12. The method of claim 10, wherein the amount of the carbon black particles within the fluid composition ranges from about 0.0001 wt % to about 25 wt %.

13. The method of claim 10 further comprising at least one additional particle selected from the group consisting of metal carbonyl particles, metal nanoparticles, carbon-based particles different from the carbon black particles, and combinations thereof.

14. The method of claim 10, wherein the carbon black particles are functionally modified carbon black particles having at least one functional group selected from the group consisting of a sulfonate, a sulfate, a sulfosuccinate, a thiosulfate, a succinate, a carboxylate, a hydroxyl, a glucoside, an ethoxylate, a propoxylate, a phosphate, an ethoxylate, an ether, an amine, an amide, an alkyl, an alkenyl, a phenyl, benzyl, a perfluoro, thiol, an ester, an epoxy, a keto group, a lactone, a metal, an organometallic group, an oligomer, a polymer, and combinations thereof.

15. The method of claim 10, wherein the carbon black particles are covalently-modified carbon black particles having at least one covalent modification selected from the group consisting of oxidation; free radical additions;
addition of carbenes, nitrenes and other radicals; arylamine attachment via diazonium chemistry; and combinations thereof.

16. The method of claim 10, further comprising at least one surfactant in an amount effective to suspend the carbon black particles in the base fluid.

17. The method of claim 10, wherein the carbon black particles have an average particle size less than about 999 nm.

18. The method of claim 10, wherein the carbon black particles have a Brunauer-Emmett-Teller (BET) surface area less than about 450 m²/g

19. A method comprising:
circulating a fluid composition into a subterranean reservoir wellbore;
wherein the fluid composition comprises a base fluid selected from the group consisting of a drilling fluid, a completion fluid, a production fluid, a stimulation fluid, and combinations thereof; and wherein the fluid composition comprises carbon black particles having a Brunauer-Emmett-Teller (BET) surface area less than about 450 m²/g.

20. The method of claim 19, further comprising performing a procedure selected from the group consisting of well logging, drilling a well, completing a well, fracturing a formation, acidizing a formation, cementing a subterranean reservoir wellbore, altering the wettability of a formation surface, altering the wettability of a wellbore surface, and combinations thereof.
